(19) United States
(12) Patent Application Publication
(10) Pub. No.: US 2009/0166481 A1
(43) Pub. Date: Jul. 2, 2009

(54) Device for simulating breast-feeding

(76) Inventor: Sheng Zhong Chen, Taipei (TW)

Correspondence Address: SAM CHEN, 7F-1, 293, ROOSEVELT ROAD, SEC 3, TAIPEI, TW

(21) Appl. No.: 11/967,260

(22) Filed: Dec. 31, 2007

(51) Int. Cl. A47D 15/00; A61J 9/00

(52) U.S. Cl. 248/102; 215/11.1

(57) ABSTRACT

A device for simulating breast-feeding is disclosed. In one embodiment the device includes a resilient, bell shaped cup adapted to snugly put on a human breast and a shoulder strap attached to two opposite positions of a rear edge of the cup. A nursing bottle is adapted to removably dispose in the cup with its nipple projecting out of a front opening of the cup such that the device can look and act like a human breast for feeding a baby.

### BACKGROUND OF THE INVENTION

1. Field of Invention

The invention relates to devices for simulating breast-feeding and more particularly to such a device having a resilient, bell shaped cup adapted to snugly put on the breast, and a nursing bottle removably disposed in the cup with its nipple projecting out of a front opening of the cup such that the device can look and act like a human breast for feeding a baby.

2. Description of Related Art

Breast-feeding has resurged in recent years. Breast-feeding has the benefit of strengthening the nurturing feelings the mother has towards her baby and breast-feeding benefits both mother and child. It is recognized that human breast milk is the best source of nourishment for human infants.

However, many mothers are not good in breast-feeding especially for young, new mothers. In often times new mothers are anxious during breast-feeding. Therefore, there have been numerous suggestions in prior patents for breast-feeding. For example, U.S. Pat. No. 4,815,977 discloses a breast-feeding trainer. But there are no inventions of which the inventor is aware that simulate the breast of a new mother to feed her baby. The present invention is intended to fill this gap in the art.

### SUMMARY OF THE INVENTION

It is therefore one object of the invention to provide a device having a shoulder strap and a resilient, bell shaped cup adapted to snugly put on a human breast. A nursing bottle is removably disposed in the cup with its nipple projecting out of a front opening of the cup such that the device can look and act like a human breast for feeding a baby.

The above and other objects, features and advantages of the invention will become apparent from the following detailed description taken with the accompanying drawings.

### BRIEF DESCRIPTION OF THE DRAWINGS

FIG. 1 is a perspective view of a first preferred embodiment of device for simulating breast-feeding according to the invention;

FIG. 2 is a view similar to FIG. 1 where a nursing bottle is about to insert into the cup through the surface opening;

FIG. 3 is a longitudinal sectional view of the device with the nursing bottle being disposed substantially horizontal in the cup in a ready state;

FIG. 4 is a view similar to FIG. 3 where an elastomeric nursing bottle is bent in the cup;

FIG. 5 is a view similar to FIG. 3 where an elastomeric nursing bottle being disposed substantially as an L;

FIG. 6 is a view similar to FIG. 3 where another nursing bottle having a larger reservoir being disposed substantially horizontal in the cup in a ready state;

FIG. 7 is an environmental view of the device being worn by a mother;

FIG. 8 is a view similar to FIG. 7 where a baby is being fed by the device by the mother;

FIG. 9 is a perspective view of a second preferred embodiment of device for simulating breast-feeding according to the invention; and

FIG. 10 is a longitudinal sectional view of a third preferred embodiment of device for simulating breast-feeding according to the invention, showing the process of positioning a nursing bottle in the cup.

### DETAILED DESCRIPTION OF THE INVENTION

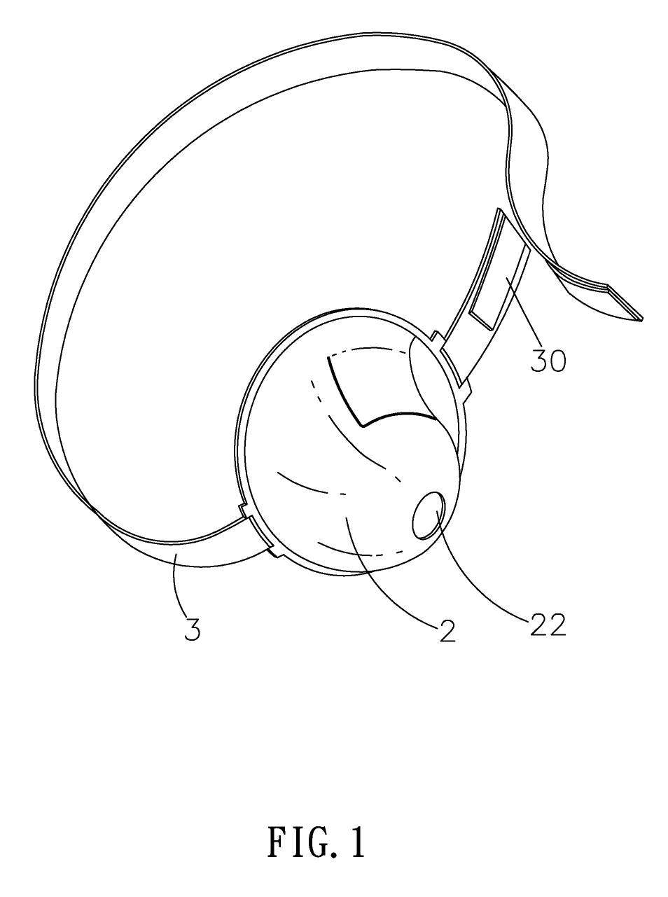

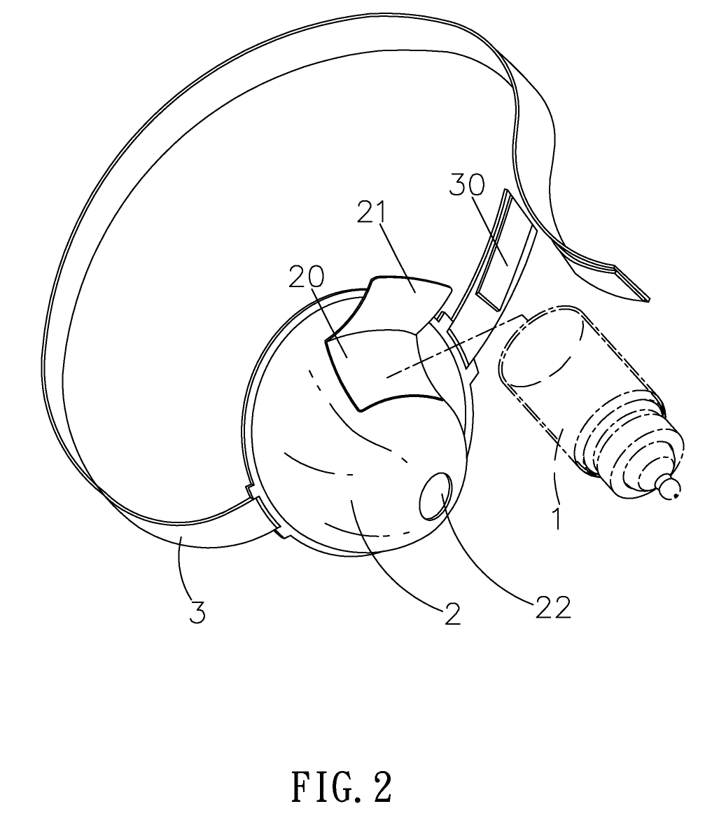

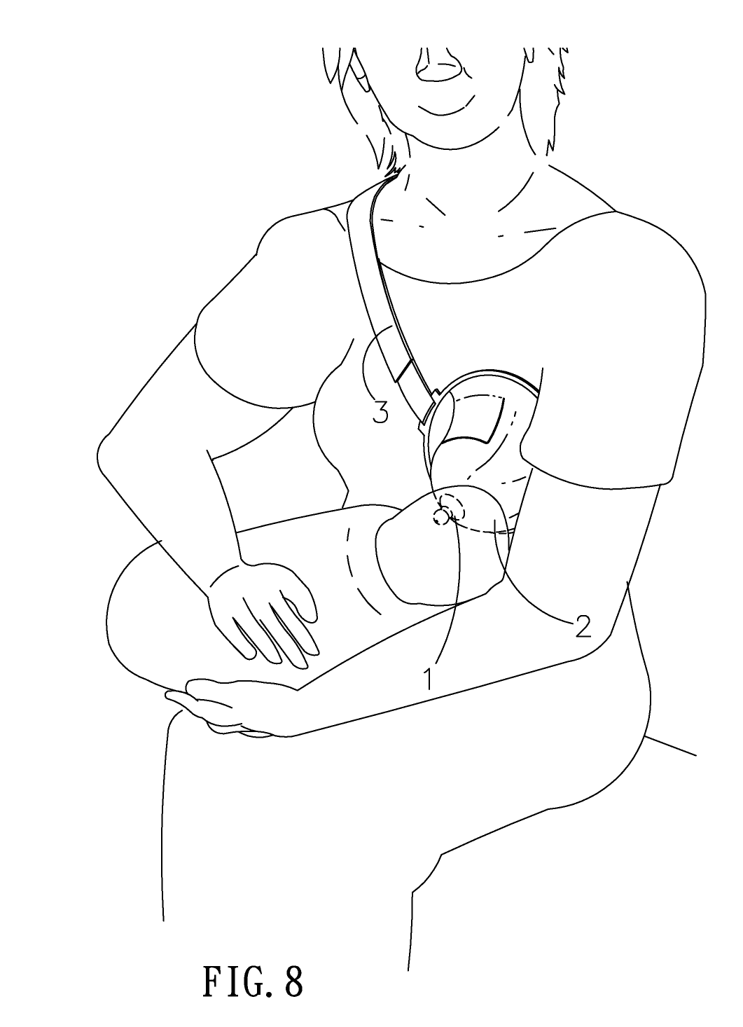

Referring to FIGS. 1 to 8, a device for simulating breast-feeding in accordance with a first preferred embodiment of the invention is shown. The device comprises a resilient, bell shaped cup 2. Preferably, the cup 2 is formed of silicon rubber or elastomeric material. The cup 2 is either transparent or has a color similar to human skin so as to be aesthetic. The cup 2 comprises an internal space 20, a front opening 22, a rectangular surface opening 20 between the opening 22 and its rear annular edge, and a flap 21 attached to a rear end of the surface opening 20. The flap 21 also has the functions of keeping initial temperature of the internal of the cup 2 for a prolonged period of time and preventing foreign pollutants from entering into the cup 2.

Thickness of the cup 2 is not even. Preferably, the lower portion of the cup 2 is padded so that the space 20 occupies about two-thirds of the size of the cup 2. Also, the rear edge of the cup 2 is structurally enhanced so as to support the weight of the cup 2 and more.

The device further comprises a shoulder strap 3 divided into two sections in which one section has one end attached to one position of the rear edge of the cup 2 and the other end formed with a first fastener on its inner surface; and the other section has one end attached to the other opposite position of the rear edge of the cup 2, and the other end formed with a second complementary fastener on its outer surface. The first and the second fasteners are implemented as a Velcro fastener 30 for allowing an easy wearing of the device or taking off of the device. Alternatively, the fastener is a hook fastener in other embodiments.

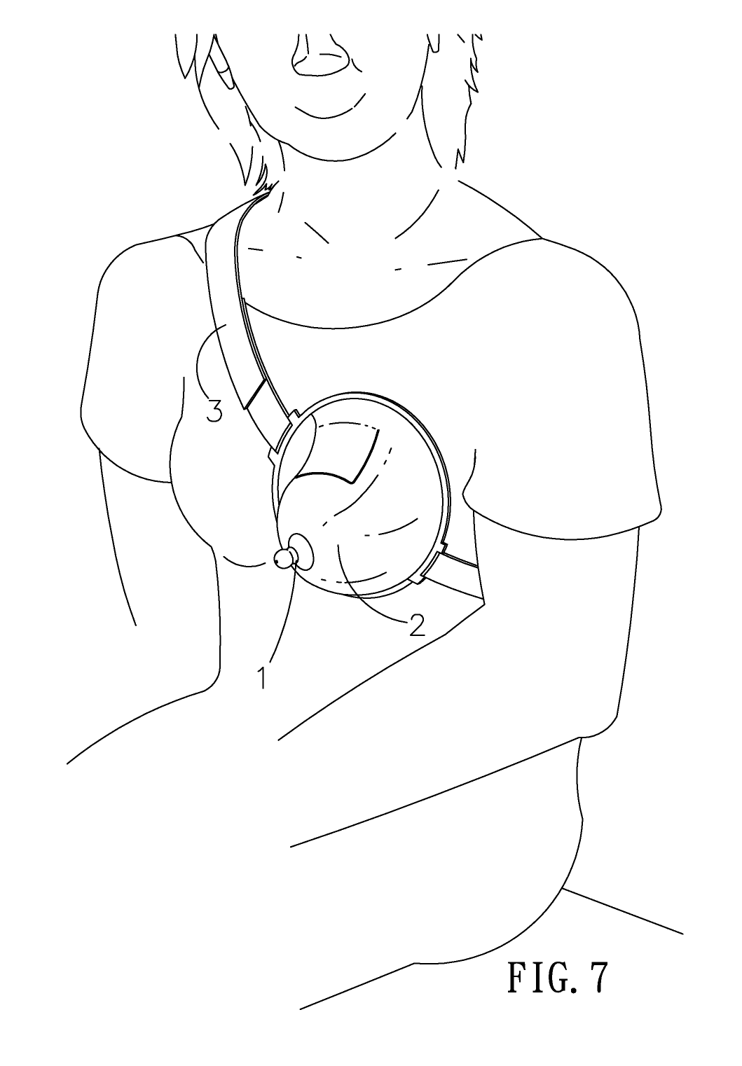

In use a mother wears the device by putting the cup 2 onto her breast (e.g., left breast as shown in FIG. 7). Next, put the shoulder strap 3 across the right shoulder and the left armpit and fasten same by attaching two complementary portions of the Velcro fastener 30 together by pressing. Next, the mother can insert a nursing bottle 1 full of milk or other liquid into the space 20 through the surface opening 22 by opening the flap 21. Finally, the nursing bottle 1 has its nipple projecting out of the front opening 22 of the cup 2 and securely rests on a bottom of the space 20.

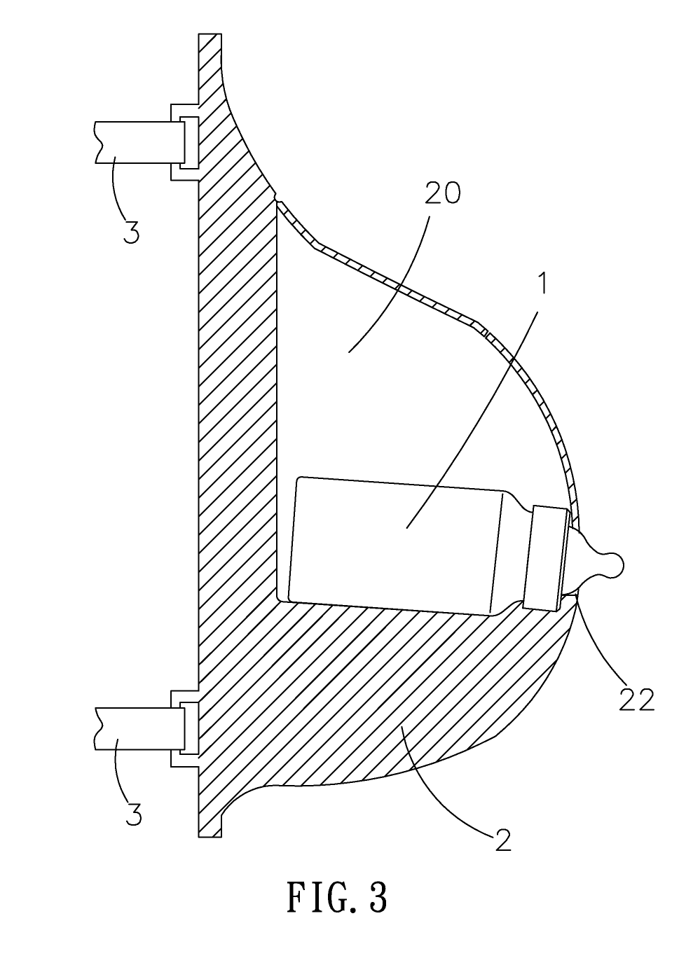

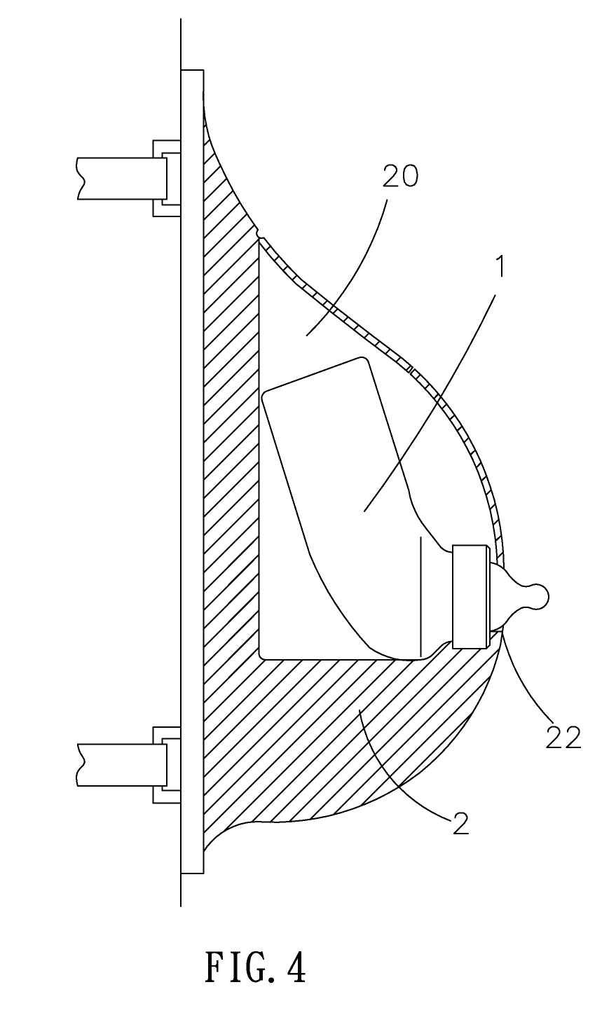

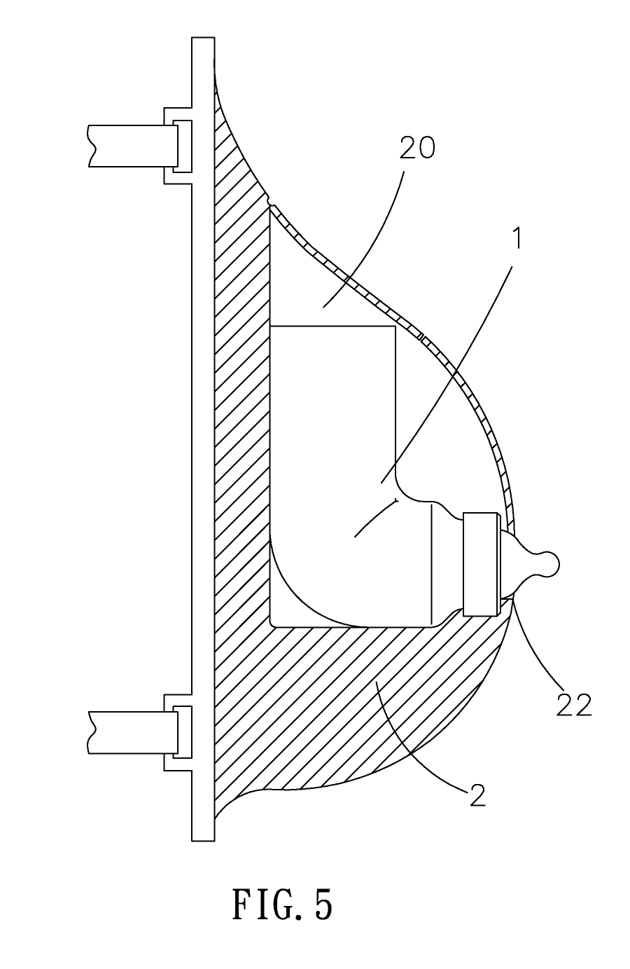

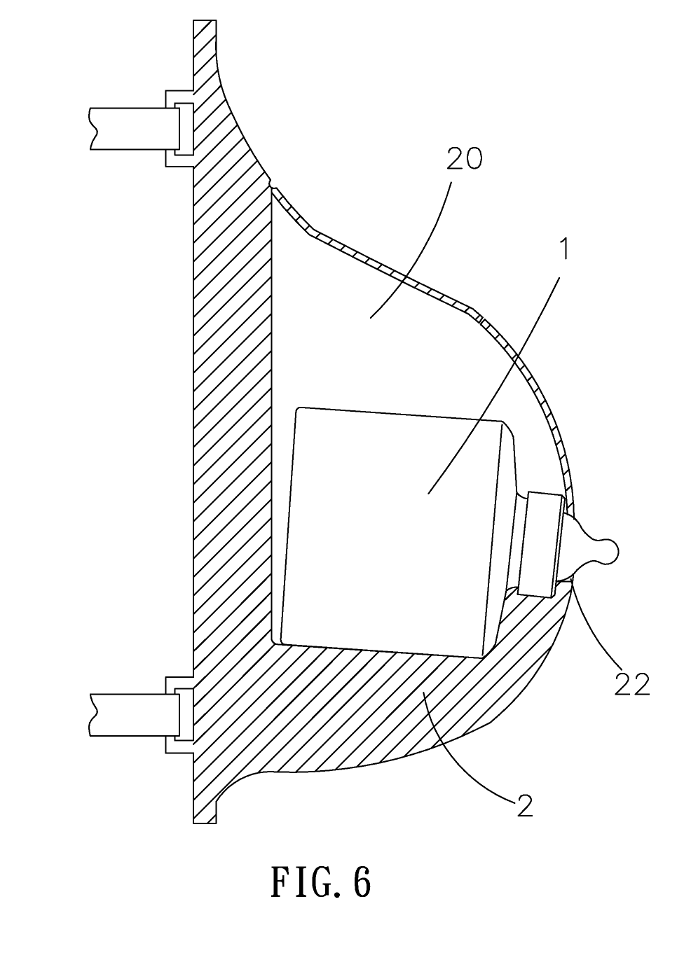

As shown in FIG. 3, the nursing bottle 1 is disposed substantially horizontal in the space 20. As shown in FIG. 4, the nursing bottle 1 is bent, i.e., the nursing bottle 1 required to be one made of flexible material (e.g., elastomer). As shown in FIG. 5, the nursing bottle 1 is disposed substantially as an L, i.e., the nursing bottle 1 also required to be one made of flexible material (e.g., elastomer). Alternatively, as shown in FIG. 6, another heavier nursing bottle 1 having a larger reservoir is rested on the bottom of the space 20. The bottom of the space 20 is elastically deformed (i.e., recessed) due to the nature of the silicon rubber after a great force exerting thereon.

The nipple is placed in the mouth of a baby who then suckles, for example, milk from the nursing bottle 1. In brief, the device looks and acts like a human breast for feeding a baby.

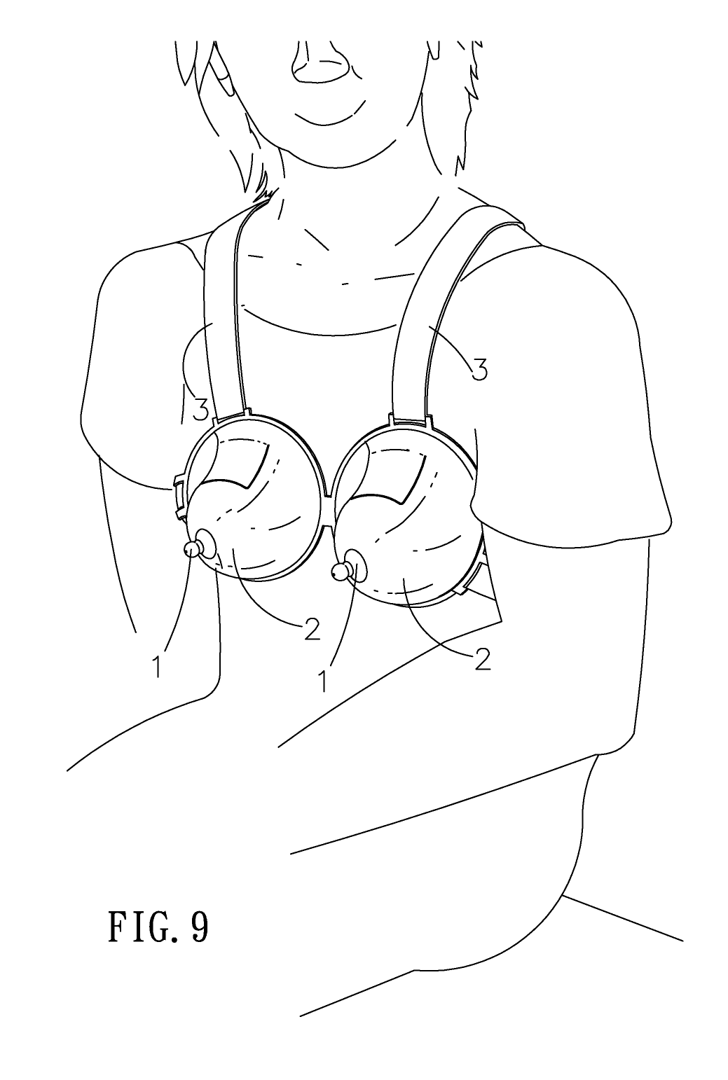

Referring to FIG. 9, a device for simulating breast-feeding in accordance with a second preferred embodiment of the invention is shown. The characteristics of the second preferred embodiment are detailed below. The device comprises two cups 2 connected together by a central panel (not numbered), a nursing bottle 1 being adapted to dispose in each cup 2 with its nipple being projected out of the front opening of the cup 2, and left and right shoulder straps 3 in which an arc distance of two ends of either shoulder strap 3 is about one-third of the periphery of the rear edge of the cup 2. The second preferred embodiment aims at allowing a mother to feed two babies (i.e., a twin) at the same time. Alternatively, one nursing bottle 1 is full of milk and the other nursing bottle 1 is full of water so that a baby may suck one nursing bottle 1 at one time and suck the other nursing bottle 1 at the other time.

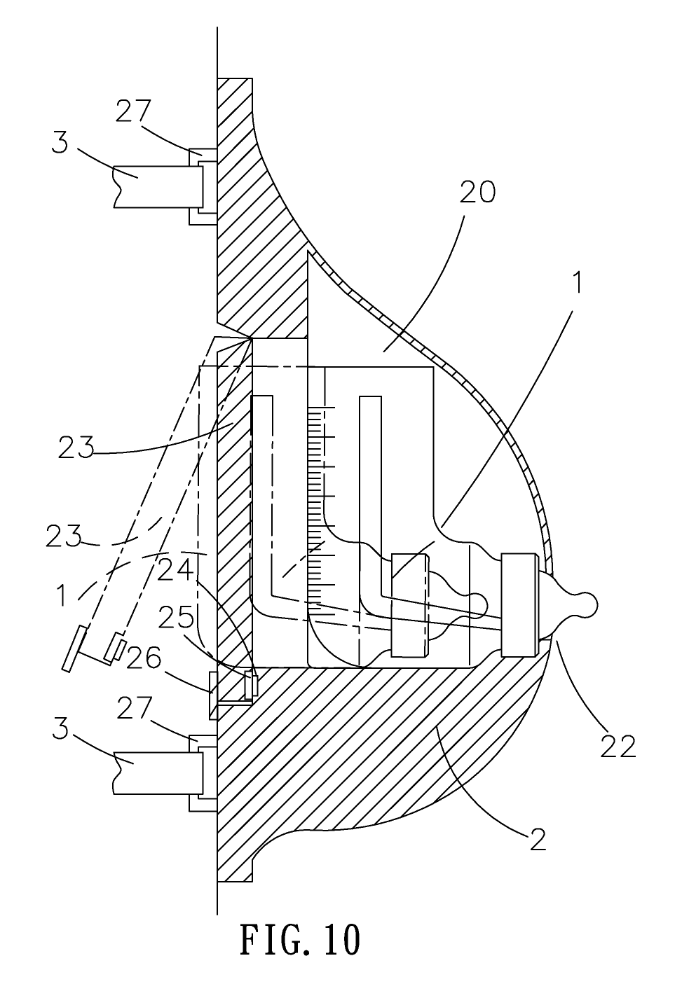

Referring to FIG. 10, a device for simulating breast-feeding in accordance with a third preferred embodiment of the invention is shown. The characteristics of the third preferred embodiment are detailed below. A cover 23 is hingedly attached to a top of an annular rear end of a cup 2. A male fastener 24 is provided on an inner surface of a lower end of the cover 23. A female fastener 25 is provided on a lower end of the rear opening of the internal space 20. A tab 26 is provided on an outer surface of the lower end of the cover 23. Upper and lower loops 27 are provided on the rear end of the cup 2 so that a shoulder strap 3 may loop through the loops 27 to assemble a complete device with the cup 2.

In use a mother wears the device. Next, the mother can insert a nursing bottle 1 full of milk or other liquid into the space 20 through the rear opening of the cup 2 by disengaging the male fastener 24 from the female fastener 25 by pulling the tab 26. Next, the nursing bottle 1 has its nipple projecting out of the front opening 22 of the cup 2 and securely rests on a bottom of the space 20. Finally, close the rear opening of the cup 2 by securing the male fastener 24 to the female fastener 25 by snapping.

While the invention herein disclosed has been described by means of specific embodiments, numerous modifications and variations could be made thereto by those skilled in the art without departing from the scope and spirit of the invention set forth in the claims.

1-12. (canceled)

13. A device for simulating breast-feeding comprising:
a resilient cup adapted to put on a human breast, the cup including a front opening, a rear opening including a first fastener on the mouth thereof, and a cover hingedly secured to the rear opening and including a complementary second fastener adapted to secure to the first fastener by snapping; and
a shoulder strap attached to two opposite positions of the cup,
wherein in response to opening the cover a nursing bottle containing a quantity of liquid is adapted to anchor in the cup by inserting through the rear opening and projecting its nipple out of the front opening and positioning thereat.

14-19. (canceled)
